(19) United States
(12) Patent Application Publication
(10) Pub. No.: US 2016/0334021 A1
(43) Pub. Date: Nov. 17, 2016

(54) AIR SEAL DEVICE FOR A SPRAY APPARATUS IN A PAPERMAKING MACHINE

(71) Applicant: ASTENJOHNSON, INC., Charleston, SC (US)

(72) Inventors: Manfred Diebel, Nidderau (DE); Michael Harry Odell, Jyvaskyla (FI)

(73) Assignee: AstenJohnson, Inc., Charleston, SC (US)

(21) Appl. No.: 15/111,518

(22) PCT Filed: Dec. 10, 2014
(86) PCT No.: PCT/US2014/069477

§ 371 Date: Jul. 14, 2016

(30) Foreign Application Priority Data
Jan. 21, 2014 (DE) 10 2014 100 651.8

(51) Int. Cl. F16J 15/40; D21H 23/50

(52) U.S. Cl. CPC F16J 15/40; D21H 23/50

(57) ABSTRACT

A non-contacting air seal device is provided in order to reduce or minimize the ingress of external air into a fluid spray apparatus for applying a fluid coating to a moving web in a papermaking machine. The air seal device includes two air seal assemblies located in tandem with convexly curved web facing surfaces arranged offset in a direction of travel of the web and in opposing relation to one another to define an S-shaped sinusoidal path along which the web travels as it passes through the seal device and wraps a portion of each of the convexly curved web facing surface as it either enters into or exits from the fluid spray apparatus. Each air seal assembly includes a roll, a rod, or a shoe that forms the convexly curved surface over which the web passes in a non-contacting manner on an air cushion which also minimizes ingress of both ambient and boundary layer air external to the fluid spray apparatus.

### FIELD OF THE INVENTION

The invention concerns a seal device for use in a fluid spray apparatus in a papermaking process. It is specifically directed to a seal device that may be located at either, or both, the upstream entrance and downstream exit of the moving web to the fluid spray apparatus to minimize ingress of ambient and boundary layer air while supporting the web.

### BACKGROUND

In the known spray devices which apply liquid starch sizing to a moving web, it is generally required that the intake of ambient air into the sprayer be minimized or prevented altogether. The interior of the fluid spray apparatus is usually operated at a slightly negative pressure in comparison to its external environment so as to recover any spray material that does not adhere to the web. Ambient air, which may leak in from the external environment of the sprayer, or brought in as boundary layer air in motion with the web, is cold and dry in comparison to the hot, saturated air (90° C. to 95° C.) in the internal environment of the sprayer device. The ambient air causes the liquid starch which is sprayed onto the moving web to freeze and dry onto the interior surfaces of the spray device. This is highly undesirable as this solid starch will have to be removed in order for the sprayer to function properly. Cooler ambient air also reduces the ability of the web to absorb or retain material sprayed onto it, and thus reduce the efficiency of the spray apparatus. The moving web also carries with it a layer of boundary air. None of the seal arrangements currently known for fluid spray apparatuses is effective to prevent or minimize the intake of ambient air into the apparatus as they lack adequate adjustment so as to conform to the web, and they do not provide a continuous active non-contacting seal to prevent intake of air. An improved sealing arrangement to address these deficiencies is desired in order to improve spray coating efficiency and reduce down time required to remove materials that dry on the interior surfaces of the spray device.

### SUMMARY

The present invention provides a solution to these problems and is directed to a non-contacting air seal device which is intended to minimize the ingress of both ambient and boundary layer air into the internal environment of the spray apparatus, thereby improving its effectiveness and efficiency.

In one preferred arrangement, a non-contacting air seal device is provided in order to reduce or minimize the ingress of external air into a fluid spray apparatus for applying a fluid coating to a moving web in a papermaking machine. The air seal device includes first and second air seal assemblies each of which has a convexly curved web facing surfaces over which the web passes, with the convexly curved web facing surfaces arranged offset in a direction of travel of the web and in opposing relation to one another to define an S-shaped sinusoidal path along which the web travels as it passes through the seal device and wraps a portion of each of the convexly curved web facing surface as it either enters into or exits from the fluid spray apparatus. An air cushion is provided at each of the convexly curved web facing surfaces, with the air cushion being adapted to support the web. The air seal assemblies are preferably formed of one of: a perforated or slotted stationary pipe, a slotted stationary shoe, or a rotating rod, that include the convexly curved web facing surfaces. Using this arrangement, the web passes in a non-contacting manner on the air cushion which also minimizes ingress of both ambient and boundary layer air external to the fluid spray apparatus.

In one embodiment, the air seal assembly is provided as a stationary roll equipped with at least one continuous or discontinuous opening, such as a slot or series of holes, extending across its width and in fluid communication with a source of pressurized fluid.

In another embodiment, the air seal assembly is provided as a stationary curved shoe, curved convexly in cross-section, which is similarly configured so as to provide a pressurized fluid to a surface of a web.

In yet another embodiment, the seal assembly is provided as a rotating rod which creates an air cushion for the web due to its rotary motion.

Further features and embodiments of the invention are described below and in the claims, which are expressly incorporated into this Summary section, and have not been reproduced here for the sake of brevity.

### BRIEF DESCRIPTION OF THE DRAWINGS

FIG. 1 is a simplified diagram of a prior art spray apparatus for use in a web forming process;

FIG. 2 is a cross-sectional illustration of a non-contact air seal device according to a first embodiment of the invention including two fixed pipes providing a cushion of pressurized air;

FIG. 3 is a simplified cross-sectional diagram of a non-contact air seal device according to a second embodiment of the invention including two counter-rotating rods with no source of pressurized air;

FIG. 4 is an illustration of non-contact air seal device according to a third embodiment of the invention in which two curved shoes provided with a source of pressurized air are used to form the seal;

FIG. 5 is an illustration showing the minimum deflection possible for the web in an embodiment of the invention; and

FIG. 6 illustrates the four degrees of air seal adjustment to be provided to the non-contact air seals in the embodiments of the invention.

### DETAILED DESCRIPTION OF THE PREFERRED EMBODIMENTS

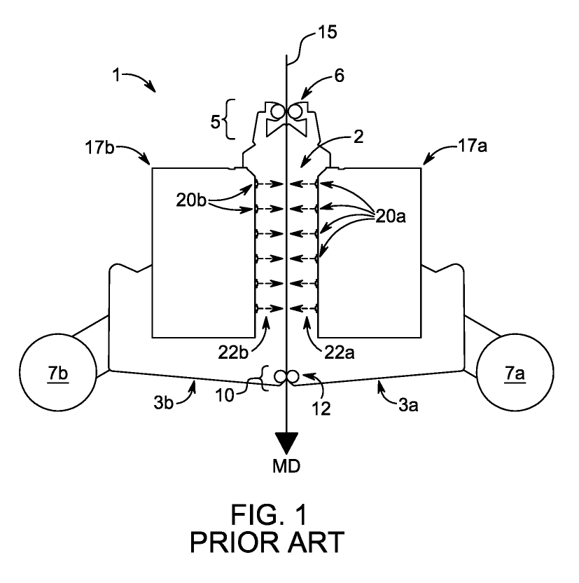

As shown in FIG. 1 (Prior Art), a web 15 is delivered at speed to the web entry area 5 of a spray apparatus 1 from an upstream process in a web forming machine (not shown). It is understood that the web 15 has a defined cross-machine direction (CD) width, as well as first and second planar surfaces. In the known apparatus 1, an inlet seal 6 according to the prior art is provided in the web entry area 5; this seal 6 usually takes the form of a pair of opposing stationary plates or pipes, each of which is located close to, but preferably not contacting, the planar surfaces of the web as it enters the entry area 5. A second seal 12 is located in the web exit area of the apparatus 1 and may be the same as, or different from, the inlet seal 6. The purpose of the inlet seal 6 and outlet seal 12 is to skim boundary layer air from the surfaces of web 15, and prevent ambient air from entering the spray environment 2 which is maintained at a slight negative pressure in relation to the external environment by means of air outlets 7a, 7b.

As the web 15 moves into the spray environment 2 of spray apparatus 1 in the direction indicated by arrow MD, a series of spray nozzle units 20a, 20b located in each of two spray beams 17a, 17b on opposite sides facing the web 15 direct an atomized process fluid spray 22a, 22b onto at least one and usually both surfaces of the web so that, as it exits spray environment 2 at sheet exit area 10, an even coating of a fluid has been applied to at least one surface. Any excess coating is drawn to the drip pan 3a, 3b from which it is removed for recirculation.

Although various types of coating can be applied to the web in the fluid spray apparatus 1, it is most common to apply a coating of fluid starch, also known as sizing. It is well known that, unless the fluid starch solution that is being sprayed onto the web is maintained at a relatively high temperature, such as above 90° C. or more, and the spray environment is kept very moist, the fluid starch will coagulate and “freeze” onto components of the spray apparatus. Various types of stationary seals 6 and 12 have been used in an attempt to prevent the ingress of external air (ambient, boundary layer) however, none has been entirely successful or particularly cost effective.

In order to overcome this problem with the prior art, it has now been found that a non-contact type air seal device, which provides an air cushion on which the web may float as it enters into, or exits from the spray environment, may successfully address these needs.

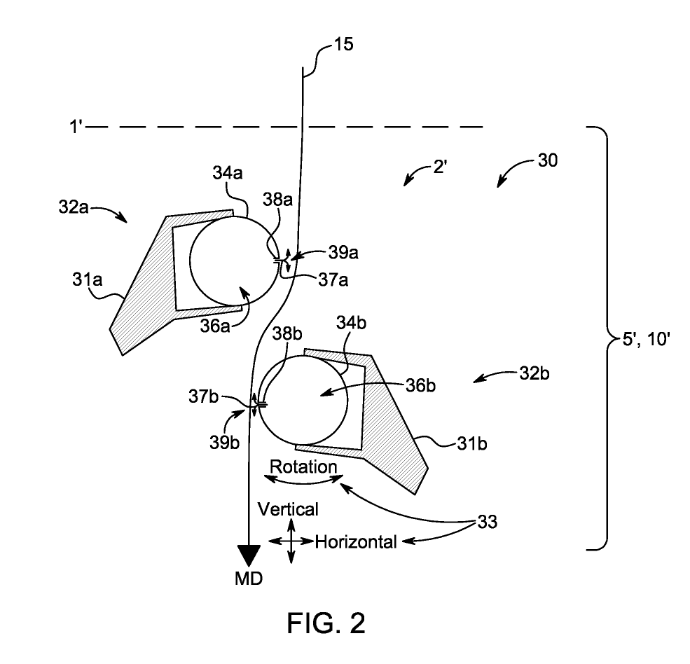

FIG. 2 provides a cross-sectional illustration of a non-contact type air seal device 30 according to a first embodiment of the invention. The device 30 is intended to be located at one or both of the upstream web entry area 5′ or downstream web exit area 10′ in the spray environment of a spray apparatus (whose presence is illustrated diagrammatically by dashed line 1′).

As shown in FIG. 2, the web 15 approaches the seal device 30 from an upstream process and moves through it into (or out of) the spray environment 2′ of the spray apparatus 1′. The seal device 30 includes two stationary air seal assemblies 32a, 32b each having an air seal pipe 34a, 34b mounted to an adjustable support 31a, 31b each of which is moveable to allow for adjustment of the stationary air seal assemblies 32a, 32b in any of the vertical, horizontal, rotational or bowing directions 33. The air seal pipes 34a, 34b are located in tandem in the seal device 30 and are offset vertically from one another to define a sinusoidal “S” shaped curved path which the web 15 follows as it passes between them as it proceeds into (or out of) spray environment 2′ of fluid spray apparatus 1′.

The interior regions 36a, 36b of air seal pipes 34a, 34b are provided with pressurized air (not shown) which is preferably maintained at temperature and humidity levels close to those of the spray environment 2′. The exterior surface of each pipe 34a, 34b includes at least one air nozzle, or a continuous or discontinuous slot oriented parallel to the axis, a series of perforations or similar opening 38a, 38b in fluid communication with the interior 36a, 36b and allowing for a controlled delivery of pressurized air through these openings. Preferably, a plurality of air nozzles is provided, arranged linearly parallel to the pipe axis. Alternatively, a series of slots or circular perforations is provided which are arranged in a linear manner along the length of the pipe parallel to its axis. As a further alternative, a continuous slot provided with a porous or foraminous material may be provided, which material allows for a uniform discharge of fluid along its length and width such as ceramic material or a sintered metal such as stainless steel. If ceramic, one suitable material may be a Pall Carbo filter element available from Pall Corp. If made from metal, a filter such as is available from GKN Sinter Metals GmbH may prove satisfactory.

During operation, pressurized air is provided to the interior regions 36a, 36b of air seal pipes 34a, 34b and exits each pipe at openings 38a, 38b as a controlled air jet 37a, 37b directed to one surface of the web 15 having sufficient pressure to form an essentially continuous air cushion 39a, 39b. This cushion serves several functions: a) it lifts the web 15 off the curved surface of the air seal pipe 34a, 34b so that the web passes over and does not contact it; b) it forces the great majority of any boundary layer air traveling with the web out and away from the spray environment 2′; and c) maintains an active leakage of hot air out of the entry or exit areas 5′, 10′ which prevents the ingress of ambient air.

In order that this may occur, the outward pressure P of the air cushion 39a, 39b delivered to the web must be great than, or equal to, the web tension T divided by the radius R of the curved surface of air seal pipe 34a, 34b, i.e.: P≧T/R. If the air pressure applied by the cushion 39a, 39b to the moving web 15 by the controlled air jet 37a, 37b as it exits opening 38a, 38b in the stationary air seal assemblies 32a, 32b satisfies this relationship, then air cushion 39a, 39b will provide a non-contacting type air seal to exclude ambient and boundary layer air. The applied air pressure P will preferably be greater than this value (i.e.: P>T/R) to ensure that leakage air is provided by air jet 37a, 37b over web facing surface of air seal pipes 34a, 34b beneath web 15. Generally speaking, P=T/R±25%

Adjustments 33 to connection means 31a, 31b allow for alterations in the position of the stationary air seal assemblies 32a, 32b in any of the vertical, horizontal, rotational or bowing directions to ensure provision of a uniform air cushion and seal, and provide continuous upstream air movement to prevent intake of ambient air. Such adjustment will often be required as the web entering the fluid spray apparatus is usually not uniform in its cross-machine direction conditions so that adjustments to the seal must be made to accommodate such variation.

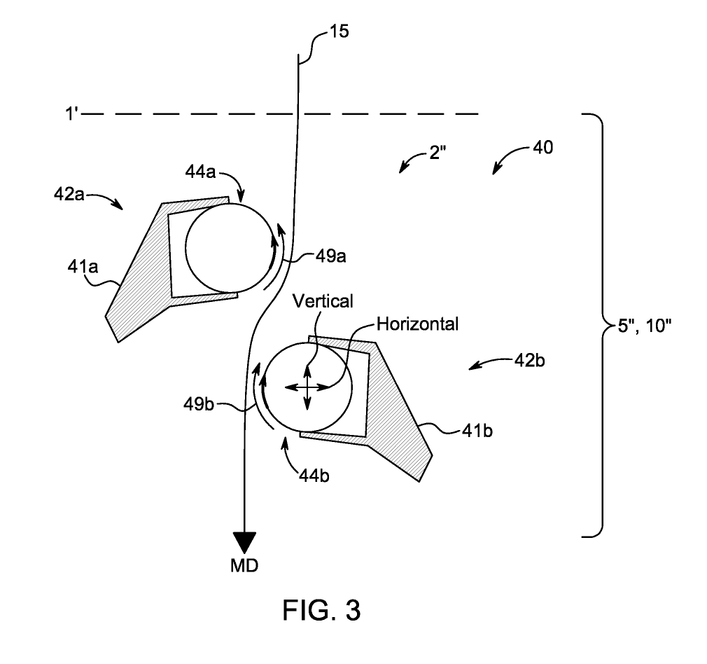

FIG. 3 provides a simplified cross-sectional diagram of a non-contacting air seal device 40 according to a second embodiment of the invention including two counter-rotating rods 44a, 44b neither of which is supplied with pressurized air as in the first embodiment. As shown, the web 15 approaches the seal device 40 from an upstream process and moves through the seal device into (or out of) the spray environment 2″ of the spray apparatus 1″ at entry area 5″ (or exits the apparatus 1″ at exit area 10″). The seal device 40 includes two stationary air seal assemblies 42a, 42b each having a rotating air seal rod 44a, 44b mounted to an adjustable support 41a, 41b each of which is moveable to allow for adjustment of the stationary air seal assemblies 42a, 42b in any of the vertical, horizontal or rotational directions or to adjust the “bow” of the rods. The air seal rods 44a, 44b are located in the seal device 40 in a tandem offset manner that causes web 15 to follow a sinusoidal “S” shaped curve as it passes between them as it proceeds into spray environment 2″ of fluid spray apparatus 1″.

Each air seal rod 44a, 44b may be hollow or solid but is rotatably mounted to adjustable support 41a, 41b such that it can be driven by any suitable drive, such as a belt, chain, gear or other drive train connected to an appropriate drive motor, such as an electric motor. The exterior surface of the rods 44a, 44b is generally smooth and unbroken, and does not contain any nozzles or other air opening.

During use, the upstream rod 44a is caused to rotate in a first direction such that its web facing surface draws air in an upstream direction so as to bring hot, saturated atmosphere from the interior spray environment 2″ of the spray apparatus 1″ over its surface. The downstream rod 44b rotates in the direction opposite to the direction of rotation of rod 44a so that it also draws hot saturated air from spray environment 2″ upstream over its web facing surface. This hot, saturated air moving over the web facing surface of each rod 44a, 44b forms a layer of boundary air to provide an air cushion 49a, 49b upon which the web 15 can proceed in a non-contact manner. As in the first embodiment, this air cushion also serves to remove or minimize any boundary layer air that may be entrained with the web, as well as provide a positive pressure force to prevent ingress of ambient air into the spray environment 2″.

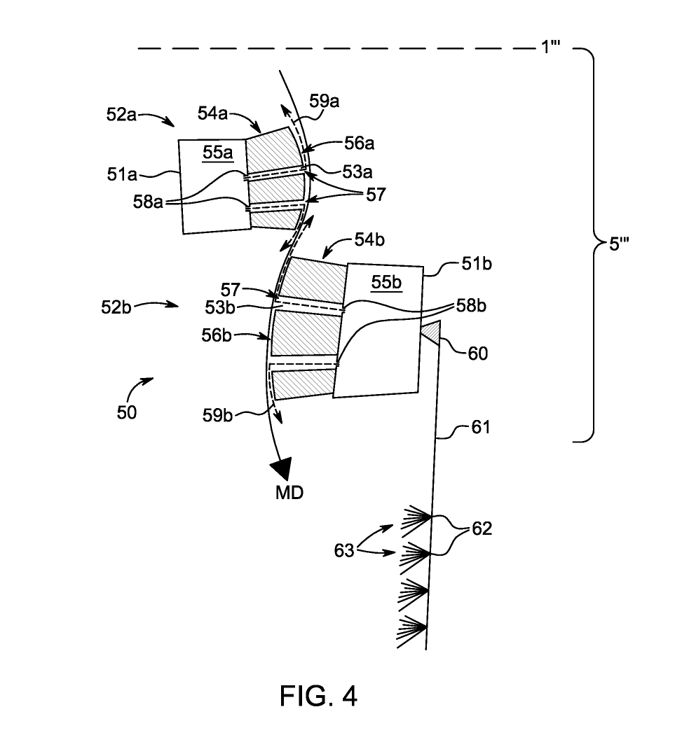

FIG. 4 provides a simplified cross-sectional representation of a non-contact type air seal according to a third embodiment of the invention. As shown in FIG. 4, the web 15 enters the spray environment 2″′ of the apparatus 1″′ at the entry area 5″′. A similar arrangement would be found if the air seal is located at the exit area 10″′ of the apparatus 1″′. A first surface of the web is directed over a first convexly curved web facing surface 56a provided by a stationary shoe 54a of a first air seal assembly 52a of a non-contact type seal device 50 in a third embodiment of the invention. Two air seal assemblies such as 52a, 52b are provided which are arranged in tandem and are offset to and facing one another so that their convexly curved web facing surfaces 56a, 56b are each oriented towards the web and one another, causing the web 15 to follow a somewhat sinusoidal “S” shaped path as it enters (or exits) the spray environment 2″' of the spray apparatus 1″'.

The stationary shoe 54a includes at least one cross-machine direction (CD) channel 53a that is supplied with hot saturated pressurized fluid 57 by at least one nozzle 58a in fluid communication with the air duct 55a located within (or separately from) a support 51a. Channel 53a extends in the CD across convexly curved web facing surface 56a and is perpendicular to the MD. The amount of pressurized hot saturated fluid 57a delivered to the at least one nozzle 58a and then to surface 56a is controlled such that the outward pressure of cushion 59a is sufficient to lift the web 15 from surface 56a while preventing ingress of boundary layer and ambient air due to leakage in both the upstream and downstream directions.

As in the first embodiment, the outward pressure P provided by cushion 59a formed by delivery of hot moist fluid via air jet 57a must be greater than, or equal to, the web tension T divided by the radius R of the curved surface 56a of shoe 54a, i.e.: P≧T/R. These curved surfaces further assist to remove any wrinkles in the web, usually near its lateral edges, before it passes into the spray environment 2″′ of spray apparatus 1″′.

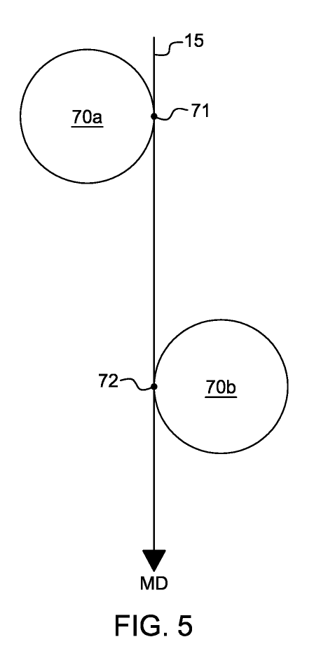

FIG. 5 illustrates the minimum deflection possible for the web in an embodiment of the invention which will allow the curved air seal assembly (such as shown in FIGS. 2 and 3) to function to provide an air cushion to the web. As shown in FIG. 5, the web 15 proceeds from an upstream process downstream towards a spray apparatus (not shown) including two offset and opposed curved surfaces 70a, 70b over which the web passes tangentially, making contact with the surfaces only at tangent points 71 and 72. The surfaces 70a, 70b are structured and arranged according to an embodiment of the invention and located such that the web 15 exerts a small force onto those surfaces at the tangent points 71 and 72. An air cushion is provided by the curved surfaces by one of either an air jet (as in the first and third embodiments) or by counter-rotating the surfaces (as rods, such as 44a, 44b). The necessary outward pressure P to be exerted by the air cushion in order to provide a non-contacting surface will be equal to the tension T of the web divided by the radius R of the surfaces 70a, 70b, i.e. P≧T/R as in the embodiments previously discussed. FIG. 5 illustrates the outer limit of adjustment available to the embodiments of the invention.

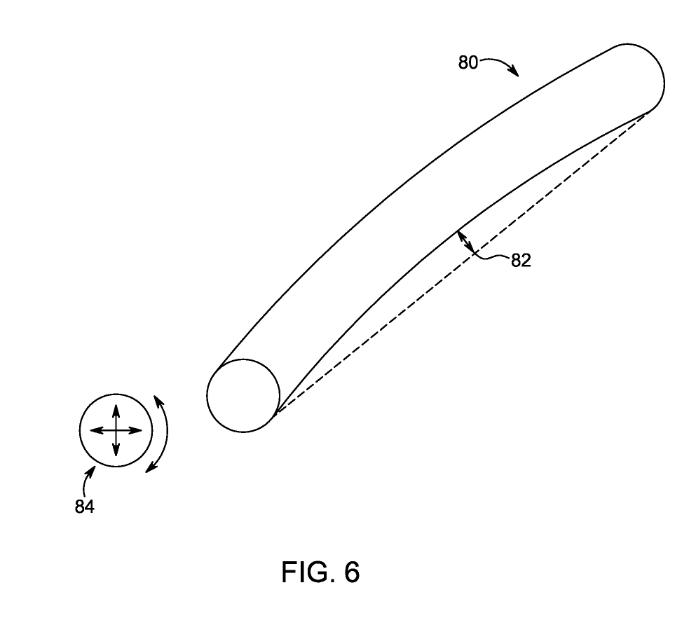

The air seal device is preferably independently and flexibly mounted with respect to the fluid spray apparatus to ensure its alignment regardless of any movement; in addition, the air seal must be adjustable along its length so that its profiles parallels that of the web entering the spray apparatus. FIG. 6 illustrates the adjustability features of the non-contact air seal assemblies of the invention. The individual seal component 80, which may be a roll, a rod, a pipe, a shoe or other curved surface, are supported in order to allow a bowing adjustment 82 so as to allow it to be deflected along a portion of its length from a linear to a curved configuration so as to better adapt and conform to the web's tensile conditions. This can be accomplished by means of the supports, such as 31a, 31b, being adjustable in the axial direction to bow the roll, rod, pipe o shoe, or through the use of a plurality of individually adjustable supports that can be independently moved toward or away from the paper web to set a desired bow shape. Additionally, component 80 should be capable of adjustment in each of the horizontal, vertical and circumferential directions as illustrated at 84.This will allow the component 80 to conform to the profile of the web as it enters (or exits) the spray apparatus so as to minimize ingress of ambient and boundary layer air and, if so equipped, direct an air jet onto the web as required.

The air seal devices of the present invention (rolls, rods, pipes, shoes) can be made of any suitable material for the intended end use including but not limited to polymers such as high density polyethylene, metals such as stainless steel, ceramics or fiberglass.

### LIST OF REFERENCE NUMBERS

1—Fluid Spray Apparatus
2—Spray environment
3a,3b—Drip pan
5, 5′—Upstream Web Entry Area to 2
6—Inlet Seal Devices (prior art)
7a, 7b—Air Outlet (vacuum)
10, 10′—Downstream Web Exit Area from 2
12—Outlet Seal Devices (Prior Art)
15—Web
17a, 17b—1^{st} & 2^{nd} Spray beam units (used in a pair)
20—Spray nozzle units (20a, 20b)
22—Fluid Spray (22a, 22b) from Spray nozzle units 20
23—Hot saturated air under pressure provided to nozzle 44 and channel 50
25—Leakage air
27 Spray beam
30—Non-contact seal device (1^{st} embodiment)
31—Adjustable Support for air pipe in spray apparatus
32a, 32b—Air seal assembly
34a, 34b—Air pipe
36 Pressurized Air Supply
37—Air Jet
38—Air Nozzle
39—Air cushion
40—Non-contact seal device (2^{nd} embodiment)
41a, 41b—Adjustable Support for assembly 42a, 42b
42a, 42b—Air seal assembly
44a, 44b—Air seal rods
49a, 49b—Air cushion formed over rotating rods 44a, 44b
50—Non-contact seal device (3^{rd} embodiment)
51a, 51b—Adjustable Support for assembly 52a, 52b
52a, 52b—Air seal assembly
54a, 54b—Shoe
55—Air Duct (CD oriented)
56—Curved shoe surface
57—Air jet (Hot saturated air)
58—Air nozzles
59—Air cushion
60—Flexible Mounting for 30, 40 or 50
61—Spray housing
62—Nozzles
63—Process liquid spray
MD—Direction of Web Movement through Apparatus 1
70a, 70b—Curved surfaces
71—First tangent point
72—Second tangent point
80—Seal component
82—Degree of bowing adjustment (for component 80)
84—Seal adjustments

1. A non-contacting air seal device for at least one of an entry or an exit in a spray apparatus for applying a fluid coating to a moving web in a web forming process, the sealing device comprising:
a. first and second air seal assemblies each including a convexly curved web facing surfaces over which the web passes;
b. he convexly curved web facing surfaces arranged offset in a direction of travel of the web and in opposing relation to one another define an S-shaped sinusoidal path along which the web travels as it passes through the seal device and wraps a portion of each of the convexly curved web facing surface;
c. an air cushion is provided at each of the convexly curved web facing surfaces, the air cushion being adapted to support the web; and
d. the air seal assemblies comprising one of: a perforated or slotted stationary pipe, a slotted stationary shoe, or a rotating roll, that include the convexly curved web facing surfaces.

2. The device according to claim 1, further comprising a pressurized air source connected to the first and second air seal assemblies that forms the air cushion.

3. The device according to claim 2, wherein the first and second air seal assemblies comprise the perforated or slotted stationary pipe or the slotted stationary shoe, and each include a series of nozzles, perforations or discontinuous slots arranged linearly parallel to a longitudinal axis of the respective first and second air seal assemblies.

4. The device according to claim 2, wherein each of the first and second air seal assemblies includes a porous material located in a linearly oriented slot.

5. The device according to claim 1, wherein the air seal assemblies comprise the rotating roll that is driven by a drive and entrains a layer of boundary air to form the air cushion.

6. The device according to claim 1, further comprising adjustable supports that mount the first and second air seal assemblies to the spray apparatus, the adjustable supports providing at least one of vertical, horizontal, and rotational positioning of the first and second air seal assemblies.

7. The device according to claim 6, wherein the adjustable supports are positionable to form a bowed orientation of the first and second air seal assemblies.

8. The device according to claim 1, wherein a angle of wrap of the web about a surface is from 0° to 25°; preferably 5° to 15°.

9. The device according to claim 1, wherein the air cushion provides to the web a pressure P=T/R±25% where T is a web tension and R is a radius of the curved surface.

10. The device according to claim 9, wherein P≧T/R .
